(19) United States
(12) Patent Application Publication
(10) Pub. No.: US 2026/0220821 A1
(43) Pub. Date: Jul. 30, 2026

(54) CODING OF DUPLICATE FACE ATTRIBUTE

(71) Applicant: TENCENT AMERICA LLC, Palo Alto, CA (US)

(72) Inventors: Fang-Yi CHAO, Dublin (IE); Chao HUANG, Palo Alto, CA (US); Shan LIU, San Jose, CA (US)

(73) Assignee: TENCENT AMERICA LLC, Palo Alto, CA (US)

(21) Appl. No.: 19/435,895

(22) Filed: Dec. 30, 2025

Related U.S. Application Data
(60) Provisional application No. 63/749,531, filed on Jan. 25, 2025.

(51) Int. Cl. G06T 9/00

(52) U.S. Cl. CPC G06T 9/001

(57) ABSTRACT

An encoding method includes receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

### CROSS-REFERENCE TO RELATED APPLICATION

This application claims priority from U.S. Provisional Application No. 63/749,531 filed on January 25, 2025, the disclosure of which is incorporated herein by reference in their entirety.

### FIELD

This disclosure is directed to coding duplicate face attributes.

### BACKGROUND

Face attributes in a mesh can be scalar values (e.g., material IDs, face group IDs), vector values (e.g., face normal), or strings (e.g., face group names) to mesh faces. The faces in a mesh can be separated into groups, and each group has its face attribute (e.g., the faces in the same group share the same face attribute). The coding of face attributes includes prediction, encoding the prediction residuals, and encoding indices. A mesh can contain many duplicate face attributes, where multiple face groups have the same attribute values. Coding efficiency can be improved by avoiding coding duplicate face attributes.

### SUMMARY

According to an aspect of the disclosure, an encoding method performed by at least one processor includes receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

According to an aspect of the disclosure, an encoder includes: at least one memory configured to store program code; and at least one processor configured to read the program code and operate as instructed by the program code, the program code including: receiving coded configured to cause the at least one processor to receive a polygon mesh comprising a plurality of faces; generating code configured to cause the at least one processor to generate an object file that groups the plurality of faces into a plurality of face groups; merging code configured to cause the at least one processor to merge at least one first face group with a second face group from the plurality of face groups based on a merging condition to generate a modified object file; encoding code configured to cause the at least one processor to encode the polygon mesh and one or more face attributes of the plurality of face groups in the modified object file; and generating code configured to cause the at least one processor to generate a bitstream comprising the encoded polygon mesh and encoded face attributes.

According to an aspect of the disclosure, a non-transitory computer readable medium storing a bitstream that is generated by an encoding method includes: receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

According to an aspect of the disclosure, a non-transitory computer readable medium storing a bitstream that is generated by an encoding method includes: receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 is an example of an object file of an input mesh with example face groups, in accordance with embodiments of the present disclosure.

FIG. 5 is an example of an object file with merged face groups, in accordance with embodiments of the present disclosure.

FIG. 6 illustrates example results based on the embodiments of the present disclosure.

FIG. 7 illustrates example results based on embodiments of the present disclosure.

FIG. 8 illustrates example results based on embodiments of the present disclosure.

FIG. 9 illustrates example results based on embodiments of the present disclosure.

FIG. 10 illustrates example results based on embodiments of the present disclosure.

FIG. 11 illustrates example results based on embodiments of the present disclosure.

FIG. 12 illustrates an example process for merging face groups, in accordance with embodiments of the present disclosure.

FIG. 13 illustrates an example computer diagram, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

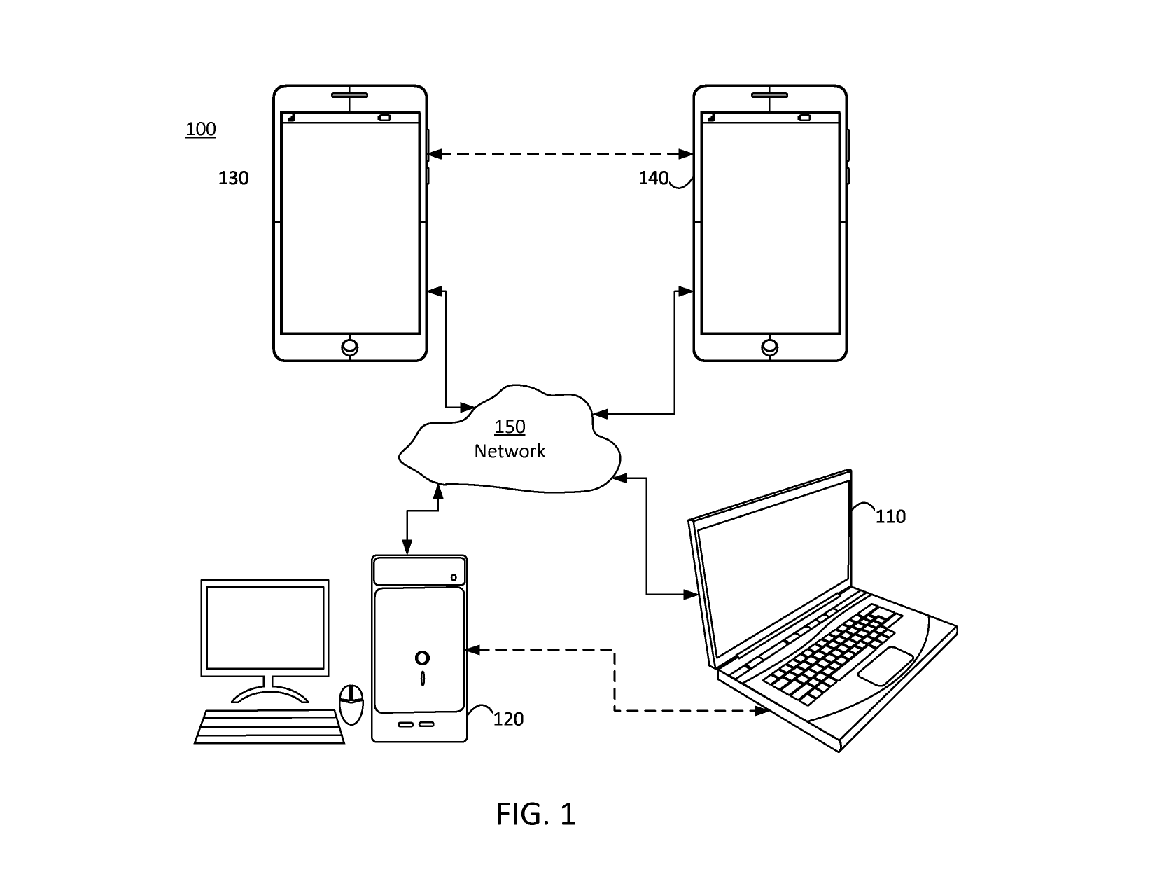

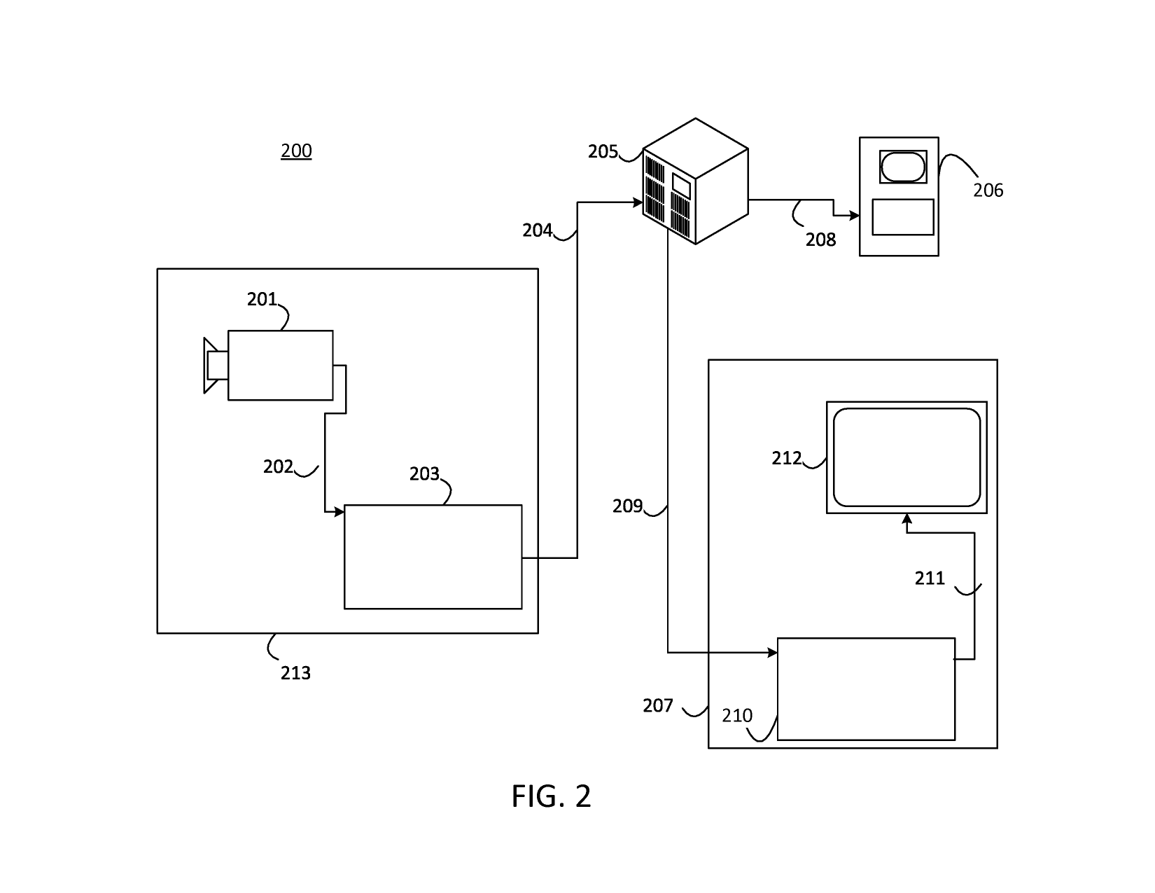

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

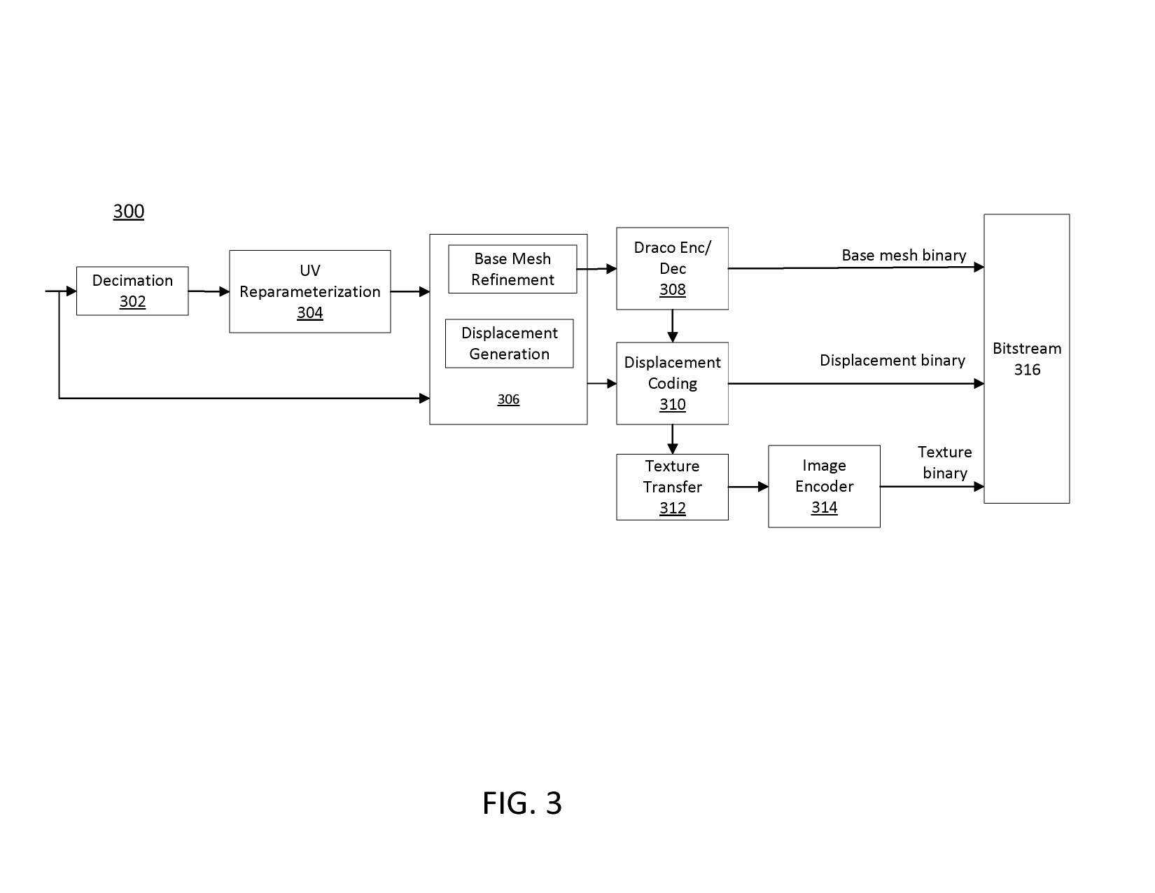

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called "UV Mapping". The UVs define a 2D position in texture space for each vertex in the mesh.

The embodiments are directed to coding methods for duplicate face attributes. To avoid coding duplicate face attribute values, the embodiments are directed to merging the face groups with the same attribute values into a group. In one or examples, the encoder first checks the face attribute value of all the face groups in the input mesh, and re-groups the faces to the same group if they have the same attribute value. All the face groups with the same attribute value are merged into the same group. After this operation, all the face groups have unique attribute values.

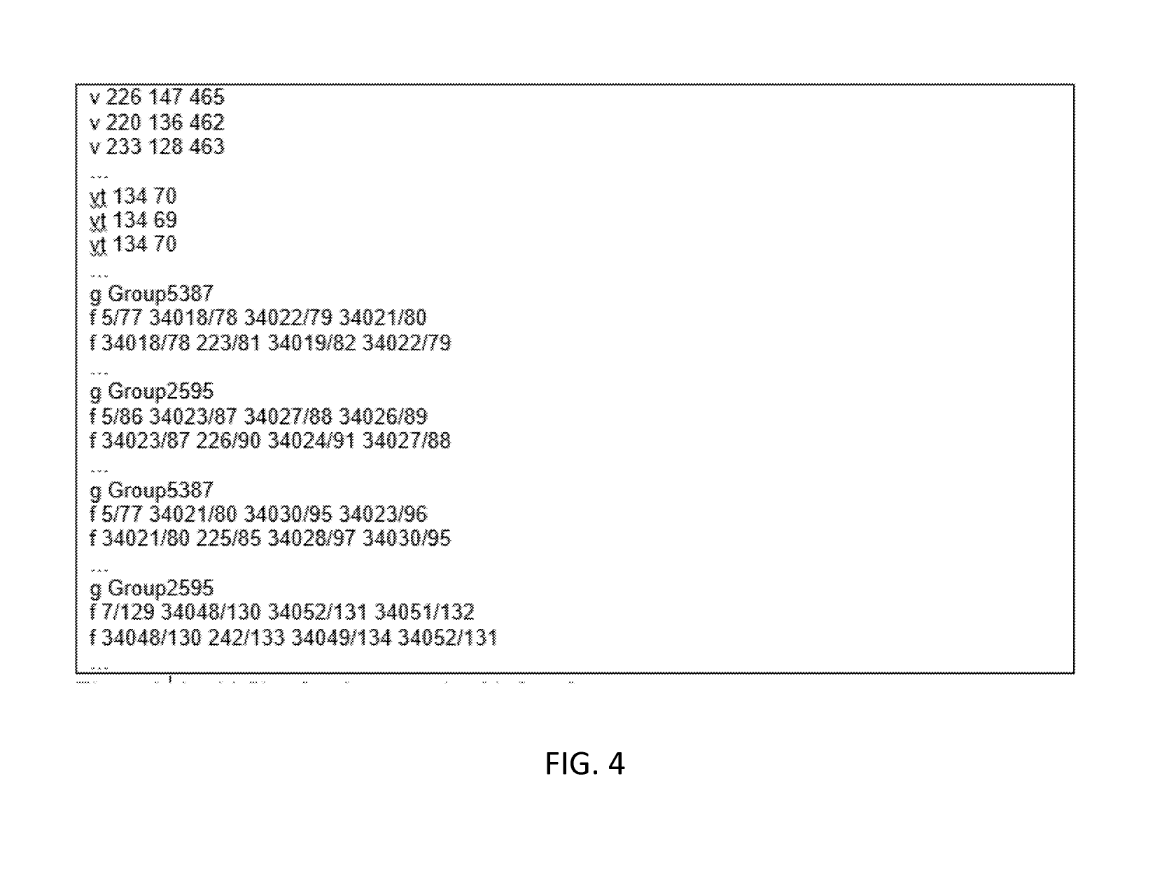

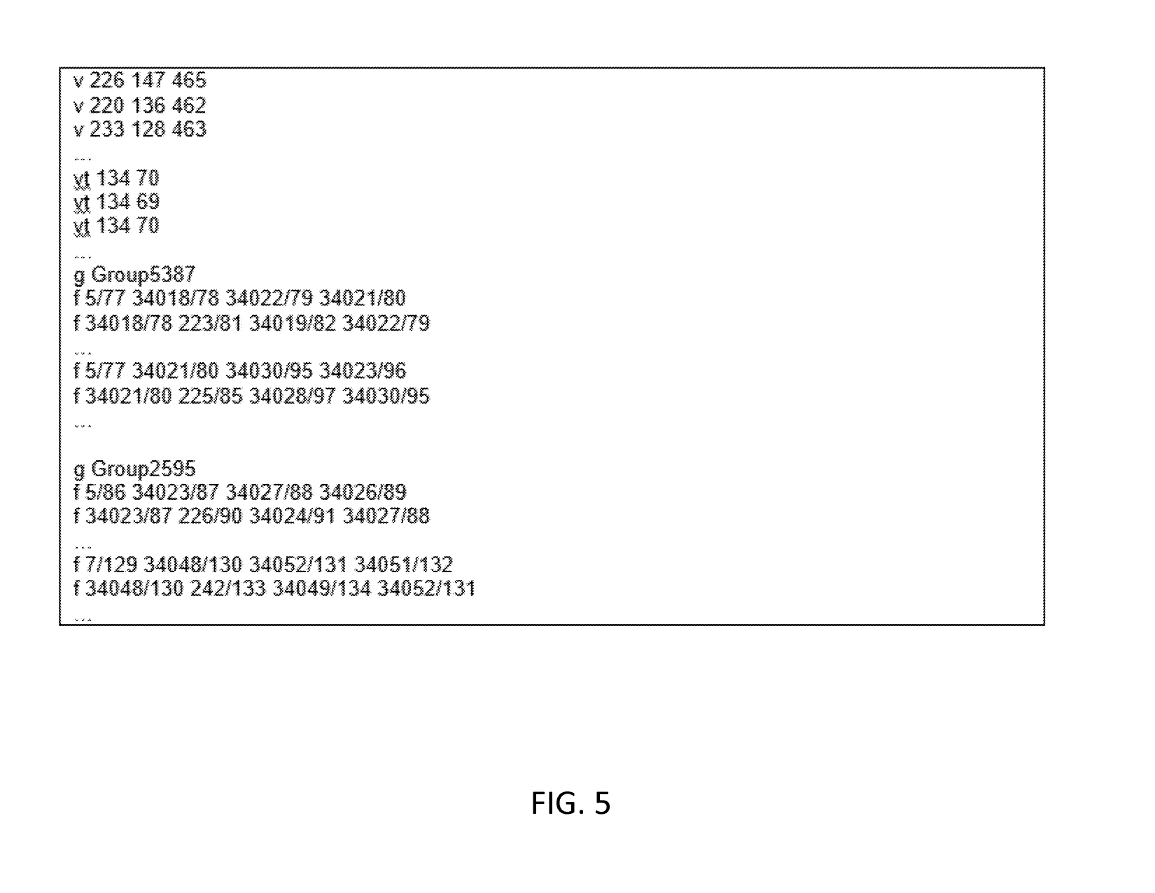

For example, FIG. 4 shows an example .obj file of an input mesh with four face groups. However, the first face group and the third face group (e.g., Group5387) have the same attribute value. The second face group and the fourth face group (e.g., Group2595), highlighted in blue, have the same attribute value. In one or more examples, to avoid coding duplicate face attribute values, the first face group and the third face group are merged into one group and the second face group and the fourth face group are merged into the other group, as illustrated in FIG. 5. Accordingly, while FIG. 4 illustrates four face groups, FIG. 5 illustrates two face groups as a result of the merging.

In one or more examples, attribute values like “Group5387” or “Group2595” may be scalar values (e.g., material IDs, face group IDs), vector values (e.g., face normal), or strings (e.g., face group names). In one or more examples, the order of the face groups and the order of the faces in a group may be changed.

In one or more examples, faces in a mesh may be organized into a same group based on having at least one common attribute. For example, the common attribute between a first face and a second face may be an attribute that affects an appearance of the face in a mesh such as texture or color. Referring to FIG. 4, the faces belonging to group Group5387 may have a same texture or color coordinate. Thus, if the first face and the second face share a same texture or color attribute, but the remaining attributes of the first and second faces groups are different from each other (e.g., attributes that do not affect appearance in the mesh), the first and second faces may be assigned to the same group, and later merged with other groups as discussed above.

In FIG. 4, “v” may refer to vertices, “vt” may refer to texture coordinates, and “f” may correspond to faces defined by UV coordinates. For example, the face group Group5387 includes a first face defined by the following coordinates: 5/77, 34018/78, 34022/79, 34021/80.

The embodiments are directed to removing redundancy in a face attribute coding by modifying the encoder to merge face groups with identical names. The embodiments result in at least 9.31% and 9.32% compression gain in the face attribute in default and optimal configuration, respectively.

The current test model uses the face group information available in the OBJ files to validate face attribute coding. Associated with each face group is a unique ID ranging between 0 and the number of face groups minus one. This ID may encode an integer face attribute that specifies for each face of the face group ID it belongs to. However, a mesh can have multiple face groups with the same attribute value (e.g., the same face group name). The current test model takes the face groups with the same face group name as different groups and assigns them different IDs, which causes redundant coding of the face attribute since these face groups have the same face attribute. Additionally, Draco, which is used to convert C0 to C1 and C2 in the input dataset, merges the face groups with the same names into the same group. Therefore, the current test model, which takes all the face groups as individuals, encodes more duplicate face attributes in C0, than in C1 and C2.

For example, in the new dataset with face attribute [1], the mesh 41_candle_stick has 580 face groups in C0 but only 18 face groups in C1 and C2. The 580 face groups in C0 are duplicates of 18 unique face groups. As illustrated above, FIG. 4 shows an example of the original OBJ file of mesh 41_candle_stick with a duplicate face group names. TMv6 regards the two face groups with the same name as two different face groups, while Draco merges the two groups (e.g., the faces in the two face groups belong to the same group).

According to one or more embodiments, face groups with identical names may be merged into a same group in the encoder (e.g., the faces in the face groups with the name share the same face group ID). After this change, the number of face groups in C0 is the same as in C1 and C2.

For example, the current test model uses the library <tiny_obj_loader.h> to load the input obj file. This library takes each face group starting with “g” as an individual group, no matter its name is the same as other groups or not. The embodiments propose to check the unique face groups in the loaded obj, give an ID for each unique face group, and assign the ID to all the faces that belong to the same group. In one or more examples, the mesh-compare in MeshProcessingTool may be updated in the same manner since it uses <tiny_obj_loader.h> to load the obj file as well.

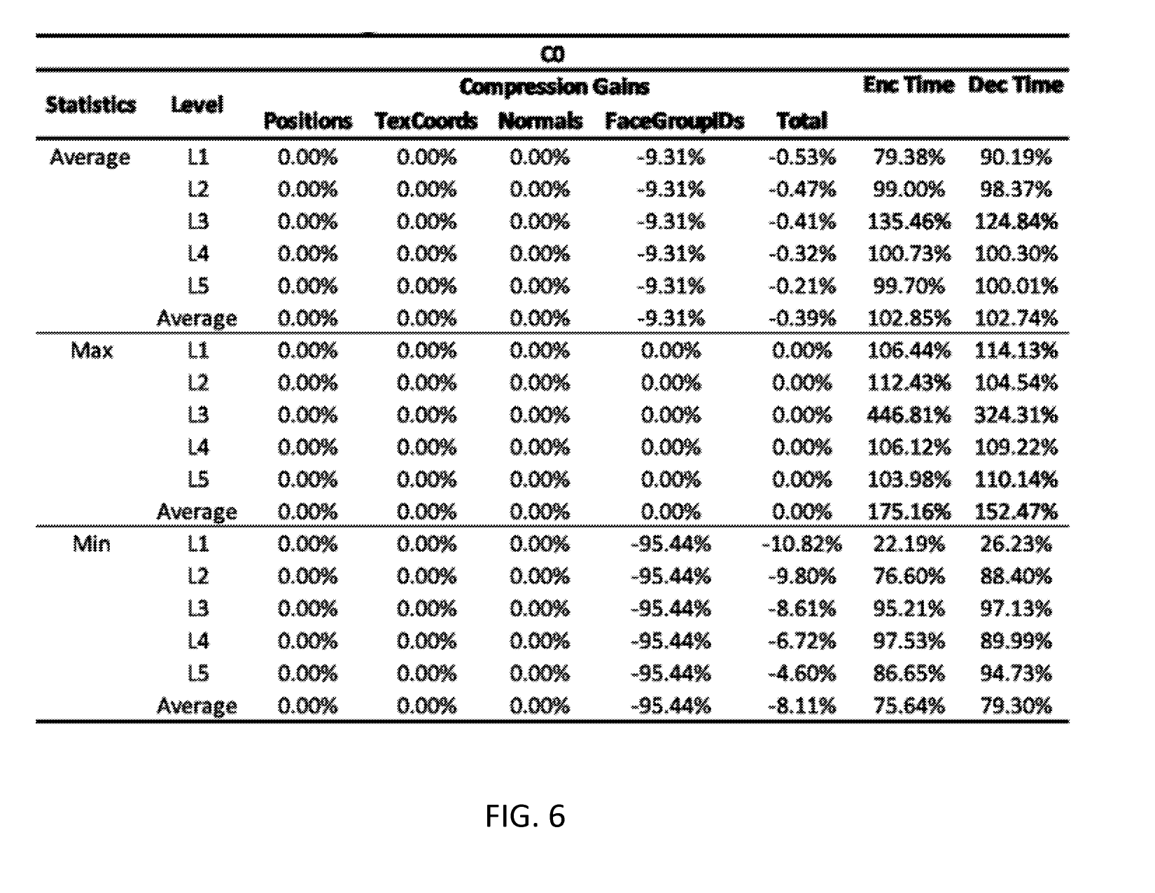

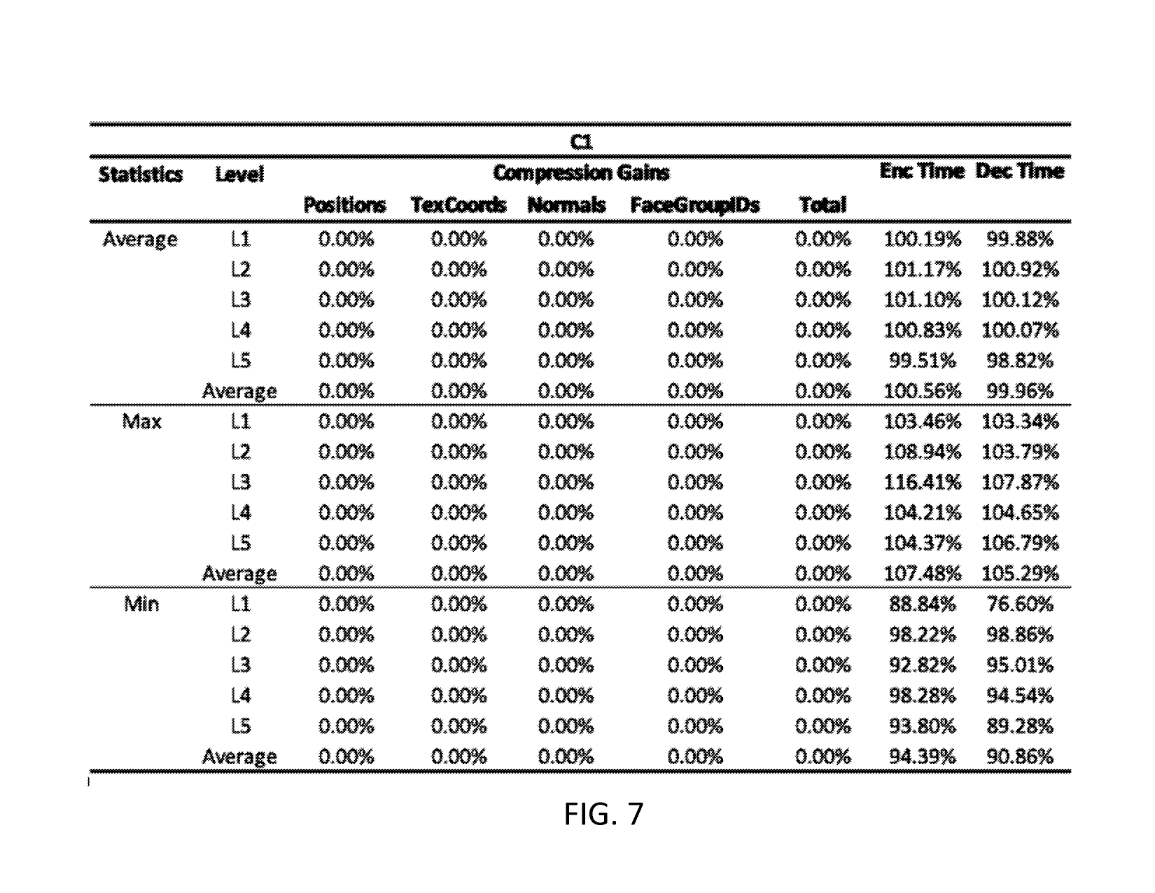

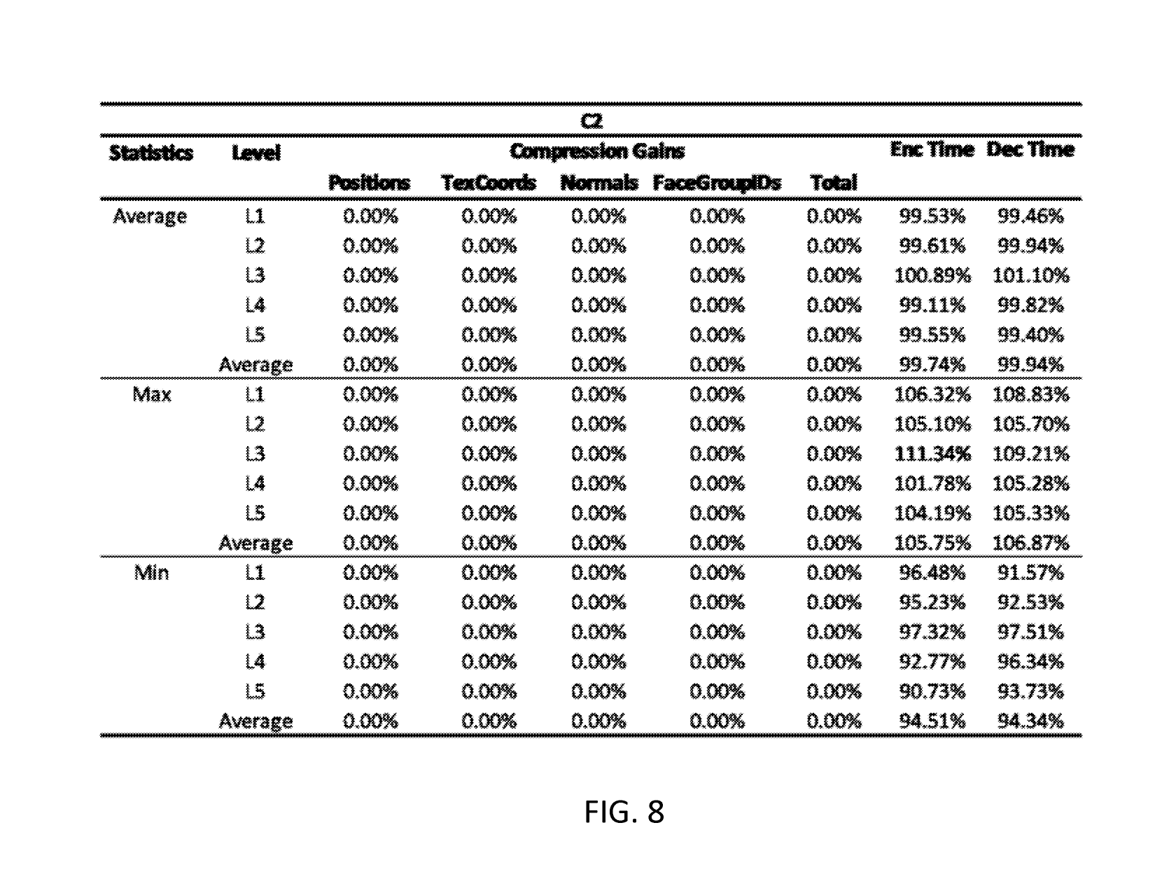

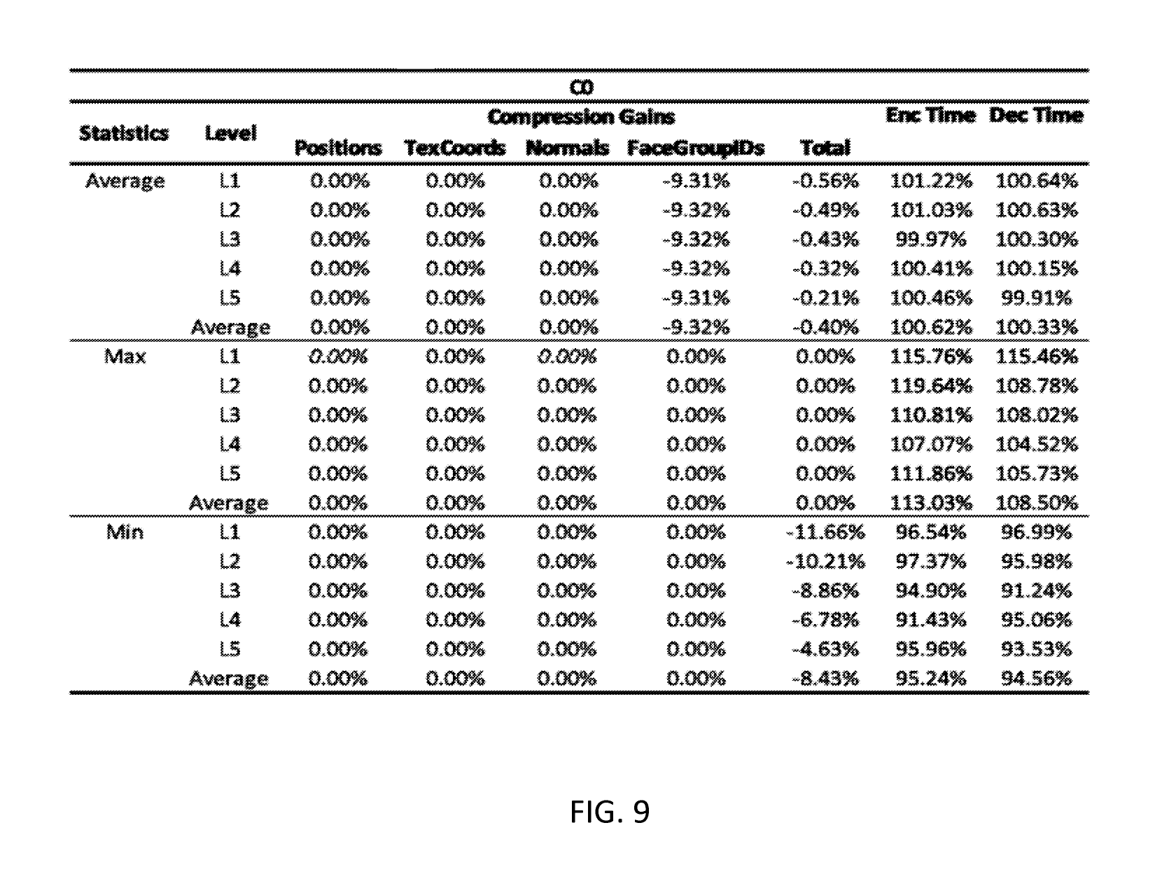

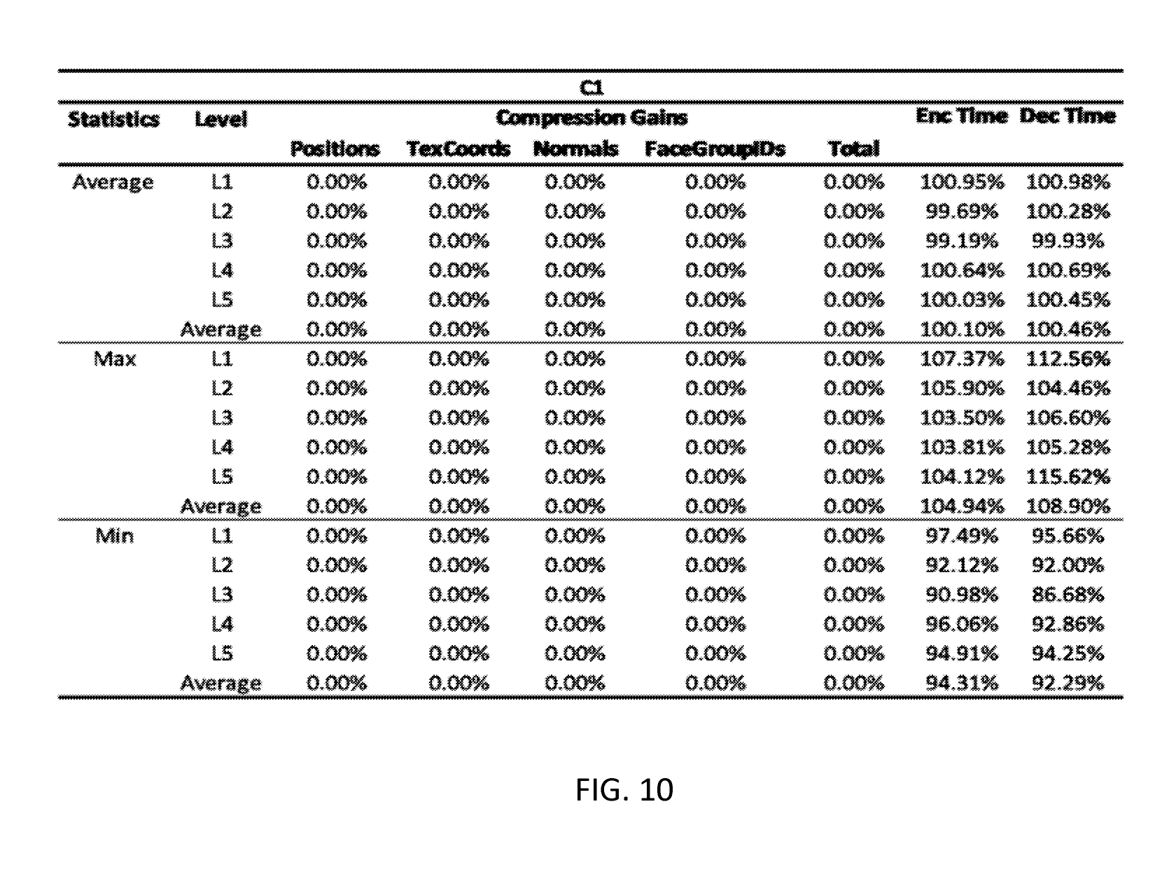

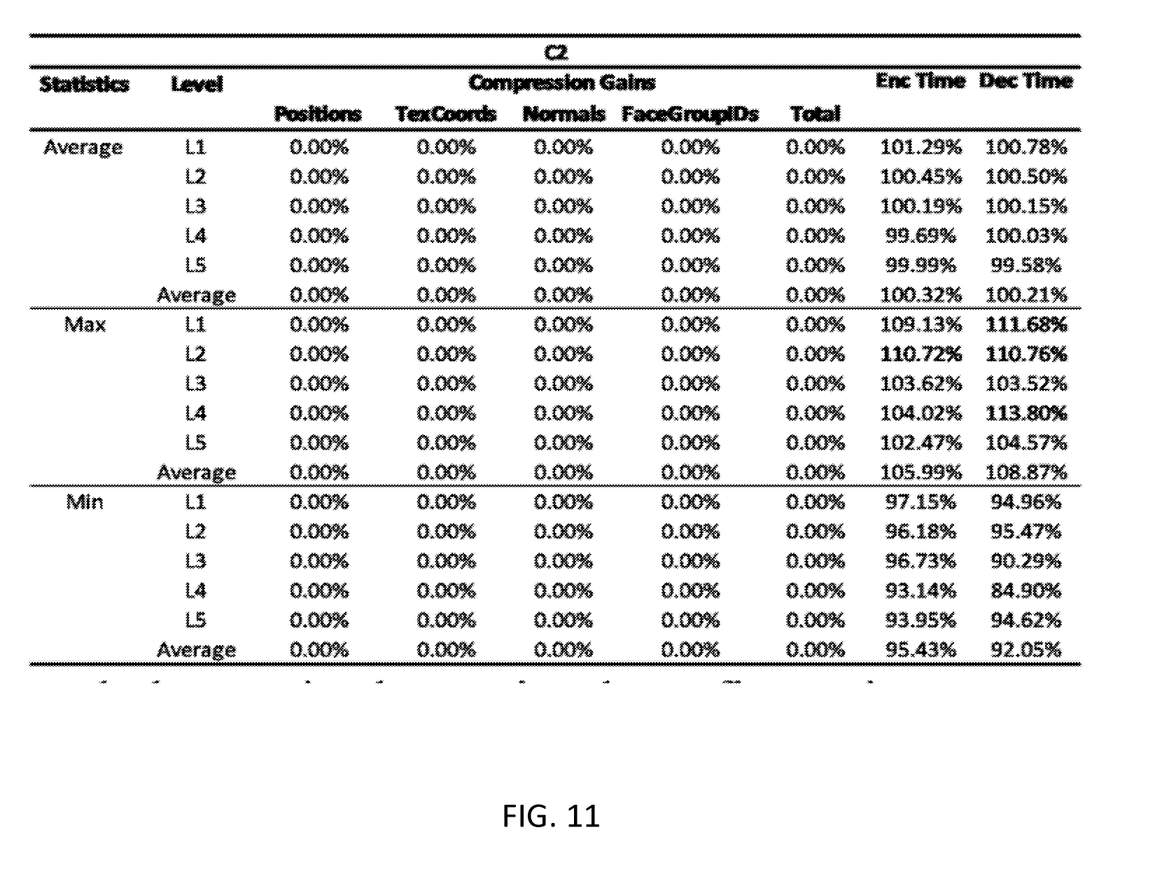

In one or more examples, the changes may be implemented on top of TMv6.1 and show the results against the test model on a default configuration (FIGS. 6-8), and with an optimal configuration (FIGS. 9-11). The new dataset with the face attribute show the advantageous results of the disclosed embodiments. The results show that the embodiments provide at least 9.31% and 9.32% compression gain in the face attribute in default and optimal configuration, respectively.

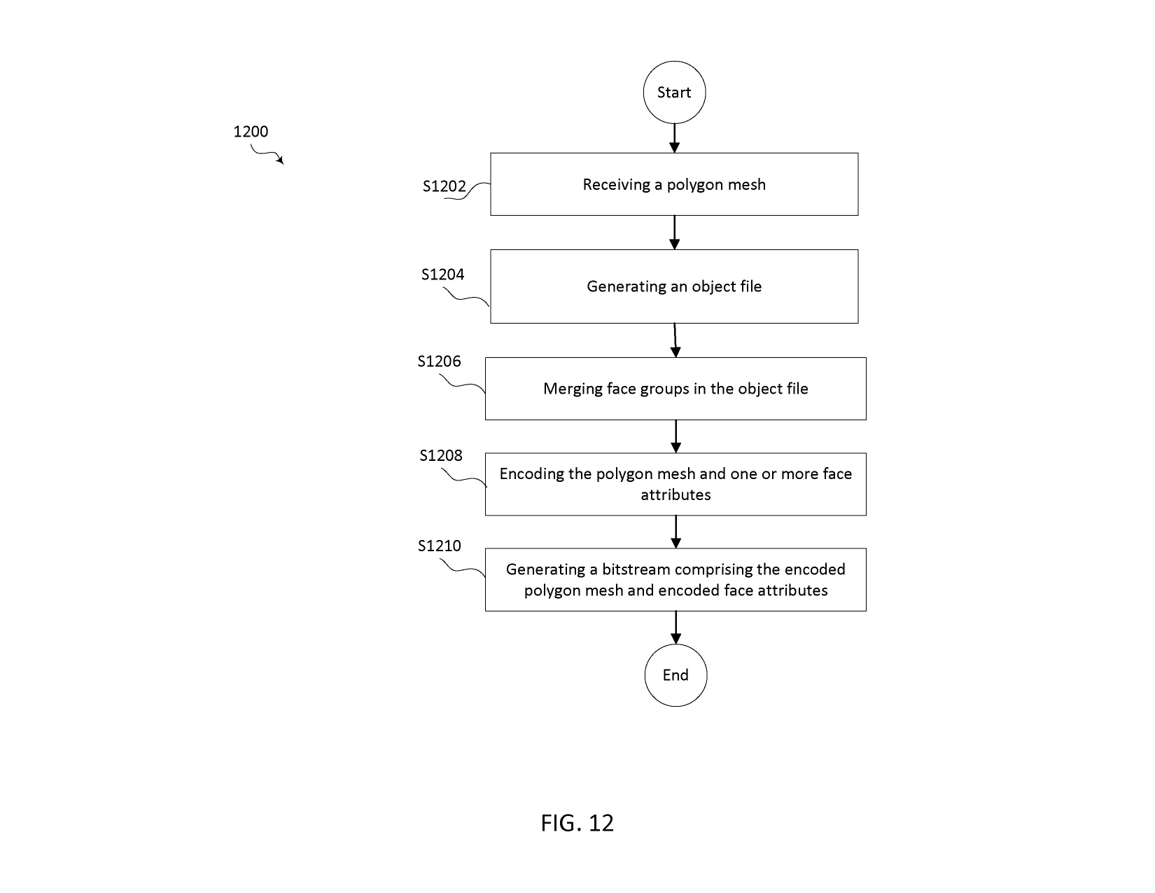

FIG. 12 illustrates an example process 1200 for merging face groups, according to one or more embodiments. The process 1200 may be performed by the encoder 200.

The process may start at operation S1202 where a polygon mesh is received. The process may proceed to operation S1204 to generate an object file such as the object file illustrated in FIG. 4. The object file may form face groups. For example, faces of the polygon mesh that share a same attribute may be assigned to a same face group. The process proceeds to operation S1206 where face groups are merged in accordance with a merging condition, where a modified object file is generated based on the merging such as the object file illustrated in FIG. 5. For examples face groups having a same ID or scalar value may be merged together. The process proceeds to operation S1208 to encode the polygon mesh and one or more face attributes in the modified object file are encoded. The process proceeds to operation S1210 to generate a bitstream comprising the encoded polygon mesh and encoded face attributes.

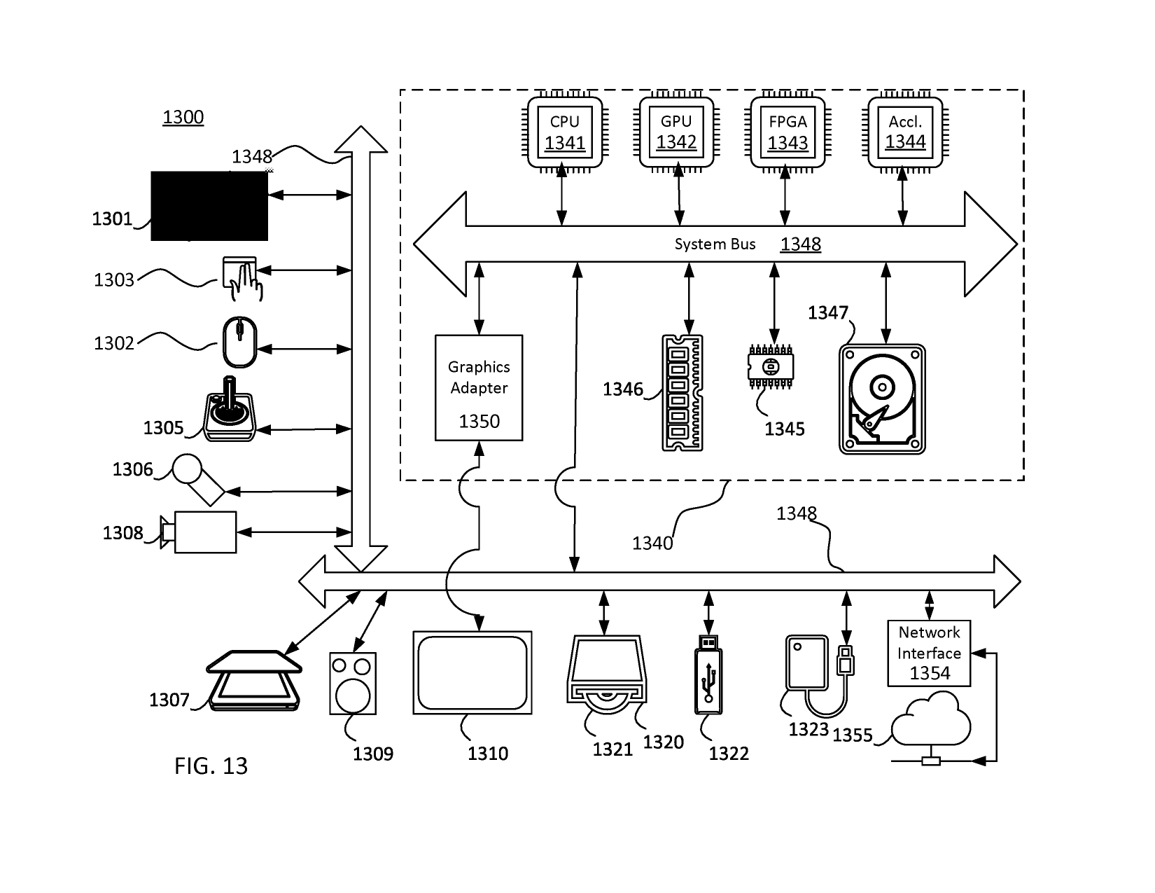

The techniques, described above, may be implemented as computer software using computer-readable instructions and physically stored in one or more computer-readable media. For example, FIG. 13 shows a computer system 1300 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 13 for computer system 1300 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1300.

Computer system 1300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1301, mouse 1302, trackpad 1303, touch screen 1310, data-glove, joystick 1305, microphone 1306, scanner 1307, and camera 1308.

Computer system 1300 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1310, data glove, or joystick 1305, but there may also be tactile feedback devices that do not serve as input devices). For example, such devices may be audio output devices (such as: speakers 1309, headphones (not depicted)), visual output devices (such as screens 1310 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 1300 may also include human accessible storage devices and their associated media such as optical media including CD/DVD ROM/RW 1320 with CD/DVD or the like media 1321, thumb-drive 1322, removable hard drive or solid state drive 1323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1300 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports

or peripheral buses 1349 (such as, for example USB ports of the computer system 1300; others are commonly integrated into the core of the computer system 1300 by attachment to a system bus as described below (for example Ethernet interface into a PC computer system or cellular network interface into a smartphone computer system). Using any of these networks, computer system 1300 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 1355. Certain protocols and protocol stacks may be used on each of those networks and network interfaces as described above.

Aforementioned human interface devices, human-accessible storage devices, and network interfaces 1354 may be attached to a core 1340 of the computer system 1300.

The core 1340 may include one or more Central Processing Units (CPU) 1341, Graphics Processing Units (GPU) 1342, specialized programmable processing units in the form of Field Programmable Gate Areas (FPGA) 1343, hardware accelerators for certain tasks 1344, and so forth. These devices, along with Read-only memory (ROM) 1345, Random-access memory 1346, internal mass storage such as internal non-user accessible hard drives, SSDs, and the like 1347, may be connected through a system bus 1348. In some computer systems, the system bus 1348 may be accessible in the form of one or more physical plugs to enable extensions by additional CPUs, GPU, and the like. The peripheral devices may be attached either directly to the core’s system bus 1348, or through a peripheral bus 1349. Architectures for a peripheral bus include PCI, USB, and the like. A graphics adapter 1350 may be included in the core 1340.

CPUs 1341, GPUs 1342, FPGAs 1343, and accelerators 1344 may execute certain instructions that, in combination, may make up the aforementioned computer code. That computer code may be stored in ROM 1345 or RAM 1346. Transitional data may be also be stored in RAM 1346, whereas permanent data may be stored for example, in the internal mass storage 1347. Fast storage and retrieve to any of the memory devices may be enabled through the use of cache memory, that may be closely associated with one or more CPU 1341, GPU 1342, mass storage 1347, ROM 1345, RAM 1346, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 1300, and specifically the core 1340 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 1340 that are of non-transitory nature, such as core-internal mass storage 1347 or ROM 1345. The software implementing various embodiments of the present disclosure may be stored in such devices and executed by core 1340. A computer-readable medium may include one or more memory devices or chips, according to particular needs. The software may cause the core 1340 and specifically the processors therein (including CPU, GPU, FPGA, and the like) to execute particular processes or particular parts of particular processes described herein, including defining data structures stored in RAM 1346 and modifying such data structures according to the processes defined by the software. In addition or as an alternative, the computer system may provide functionality as a result of logic hardwired or otherwise embodied in a circuit (for example: accelerator 1344), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) An encoding method performed by at least one processor, the method including: receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

(2) The method according to feature (1), in which the merging condition specifies that that the first face group and the second face group comprise a same scalar value.

(3) The method according to feature (2), in which the scalar value is a face group ID that identifies the first face group and the second face group.

(4) The method according to any one of features (1) – (3), in which the merging condition specifies that the first face group and the second face group comprise a same vector value.

(5) The method according to any one of features (1)-(4), in which the merging condition specifies that the first face group and the second face group comprise a same string value.

(6) The method according to any one of features (1) – (5), in which the merging condition specifies that at least one attribute between the first face group and the second face group is the same.

(7) The method according to any one of features (1) – (6), in which a first face and a second face having at least one common attribute are grouped in a same face group.

(8) The method of feature (7), in which the at least one attribute corresponds to an appearance of the polygon mesh.

(9) The method according to feature (8), in which the at least one attribute is a texture attribute or a color attribute.

(10) The method according to feature (7), in which the first face comprises a first attribute and the second face comprises a second attribute, and in which the first attribute is different from the second attribute.

(11) An encoder including: at least one memory configured to store program code; and at least one processor configured to read the program code and operate as instructed by the program code, the program code including: receiving coded configured to cause the at least one processor to receive a polygon mesh comprising a plurality of faces; generating code configured to cause the at least one processor to generate an object file that groups the plurality of faces into a plurality of face groups; merging code configured to cause the at least one processor to merge at least one first face group with a second face group from the plurality of face groups based on a merging condition to generate a modified object file; encoding code configured to cause the at least one processor to encode the polygon mesh and one or more face attributes of the plurality of face groups in the modified object file; and generating code configured to cause the at least one processor to generate a bitstream comprising the encoded polygon mesh and encoded face attributes.

(12) The encoder according to feature (11), in which the merging condition specifies that that the first face group and the second face group comprise a same scalar value.

(13) The encoder according to feature (12), in which the scalar value is a face group ID that identifies the first face group and the second face group.

(14) The encoder according to any one of features (11) – (14), in which the merging condition specifies that the first face group and the second face group comprise a same vector value.

(15) The encoder according to any one of features (11) – (14), in which the merging condition specifies that the first face group and the second face group comprise a same string value.

(16) The encoder according to any one of features (11) – (15), in which the merging condition specifies that at least one attribute between the first face group and the second face group is the same.

(17) The encoder according to any one of features (11) – (16), in which a first face and a second face having at least one common attribute are grouped in a same face group.

(18) The encoder of feature (17), in which the at least one attribute corresponds to an appearance of the polygon mesh.

(19) The encoder according to feature (18), in which the at least one attribute is a texture attribute or a color attribute.

(20) A non-transitory computer readable medium storing a bitstream that is generated by an encoding method, the encoding method including: receiving a polygon mesh comprising a plurality of faces; generating an object file that groups the plurality of faces into a plurality of face groups; merging at least one first face group with a second face group from the plurality of face groups based on a merging condition to generate a modified object file; encoding the polygon mesh and one or more face attributes of the plurality of face groups in the modified object file; and generating a bitstream comprising the encoded polygon mesh and encoded face attributes.

What is claimed is:

1. An encoding method performed by at least one processor, the method comprising:
receiving a polygon mesh comprising a plurality of faces;
generating an object file that groups the plurality of faces into a plurality of face groups;
merging at least one first face group with a second face group from the plurality of face groups based on a merging condition to generate a modified object file;
encoding the polygon mesh and one or more face attributes of the plurality of face groups in the modified object file; and
generating a bitstream comprising the encoded polygon mesh and encoded face attributes.

2. The method according to claim 1, wherein the merging condition specifies that that the first face group and the second face group comprise a same scalar value.

3. The method according to claim 2, wherein the scalar value is a face group ID that identifies the first face group and the second face group.

4. The method according to claim 1, wherein the merging condition specifies that the first face group and the second face group comprise a same vector value.

5. The method according to claim 1, wherein the merging condition specifies that the first face group and the second face group comprise a same string value.

6. The method according to claim 1, wherein the merging condition specifies that at least one attribute between the first face group and the second face group is the same.

7. The method according to claim 1, wherein a first face and a second face having at least one common attribute are grouped in a same face group.

8. The method of claim 7, wherein the at least one attribute corresponds to an appearance of the polygon mesh.

9. The method according to claim 8, wherein the at least one attribute is a texture attribute or a color attribute.

10. The method according to claim 7, wherein the first face comprises a first attribute and the second face comprises a second attribute, and wherein the first attribute is different from the second attribute.

11. An encoder comprising:
at least one memory configured to store program code; and
at least one processor configured to read the program code and operate as instructed by the program code, the program code comprising:
receiving coded configured to cause the at least one processor to receive a polygon mesh comprising a plurality of faces;
generating code configured to cause the at least one processor to generate an object file that groups the plurality of faces into a plurality of face groups;
merging code configured to cause the at least one processor to merge at least one first face group with a second face group from the plurality of face groups based on a merging condition to generate a modified object file;
encoding code configured to cause the at least one processor to encode the polygon mesh and one or more face attributes of the plurality of face groups in the modified object file; and
generating code configured to cause the at least one processor to generate a bitstream comprising the encoded polygon mesh and encoded face attributes.

12. The encoder according to claim 11, wherein the merging condition specifies that that the first face group and the second face group comprise a same scalar value.

13. The encoder according to claim 12, wherein the scalar value is a face group ID that identifies the first face group and the second face group.

14. The encoder according to claim 11, wherein the merging condition specifies that the first face group and the second face group comprise a same vector value.

15. The encoder according to claim 11, wherein the merging condition specifies that the first face group and the second face group comprise a same string value.

16. The encoder according to claim 11, wherein the merging condition specifies that at least one attribute between the first face group and the second face group is the same.

17. The encoder according to claim 11, wherein a first face and a second face having at least one common attribute are grouped in a same face group.

18. The encoder of claim 17, wherein the at least one attribute corresponds to an appearance of the polygon mesh.

19. The encoder according to claim 18, wherein the at least one attribute is a texture attribute or a color attribute.

20. A non-transitory computer readable medium storing a bitstream that is generated by an encoding method, the encoding method comprising:
receiving a polygon mesh comprising a plurality of faces;
generating an object file that groups the plurality of faces into a plurality of face groups;
merging at least one first face group with a second face group from the plurality of face groups based on a merging condition to generate a modified object file;
encoding the polygon mesh and one or more face attributes of the plurality of face groups in the modified object file; and
generating a bitstream comprising the encoded polygon mesh and encoded face attributes.
